(19) United States
(12) Patent Application Publication
(10) Pub. No.: US 2023/0259895 A1
(43) Pub. Date: Aug. 17, 2023

(54) SYSTEM AND METHOD FOR HANDLING EVENTS OF A FLEET OF PERSONAL MOBILITY DEVICES

(71) Applicant: GRABTAXI HOLDINGS PTE. LTD., Singapore (SG)

(72) Inventors: RanRan ZOU, Beijing (CN); Zhixin YU, Beijing (CN); Shuangquan HOU, Beijing (CN); Yi ZHENG, Washington, WA (US)

(21) Appl. No.: 18/011,781

(22) PCT Filed: Jul. 13, 2020
(86) PCT No.: PCT/SG2020/050403

§ 371 Date: Dec. 20, 2022

(51) Int. Cl. G06Q 10/20

(52) U.S. Cl. CPC G06Q 10/20

(57) ABSTRACT

A system and a method for handling events of a fleet of personal mobility devices (PMDs), the system including: a server configured to receive live data from the fleet of PMDs, store the live data in a first memory, and accumulated it as part of historical data. The server may include a processing logic including a classifier configured to provide prediction data based on at least one of: the historical data, the live data. The system may include an event processor configured to process an alarm of the live alarm data of the live data or the prediction alarm data of the prediction data, and generate an alert. Each PMD may include an IoT device and a power controller, and wherein the live data may include first data originating from the power controller and second data originating from the IoT device of a PMD of the fleet.

### TECHNICAL FIELD

Various aspects of this disclosure relate to a system for handling events of a fleet of personal mobility devices. Various aspects of this disclosure also relate to a method for handling events of a fleet of personal mobility devices.

### BACKGROUND

As personal mobility devices (PMDs), such as electric-scooters are taking over the FMLM (first mile last mile) transportation everywhere in the world, safety and durability are two top concerns people are trying to solve for all across the value chain, from operators to original equipment manufacturers (OEMs).

Safety issues have so far plagued the industry due to most of the existing e-scooter operators relying on OEM to build their scooters, which limits the data they have access to, sensors they can customize, and the real time actions that are available to them on faulty scooters. The industry struggles with battery incidents, durability challenges, theft and vandalism, and sometimes even crimes.

Therefore, there is a need to provide for a safer system for handling events in PMDs.

### SUMMARY

An aspect of the disclosure relates to a system for handling events of a fleet of personal mobility devices. The system may include a server configured to receive live data from the fleet of PMDs. The system may further include a first memory. The server may be configured to store the live data in the first memory, which may be accumulated as part of historical data. The server may further include a processing logic including a classifier configured to provide prediction data based on at least one of: the historical data, the live data. The live data may include live status data and live alarm data. The prediction data may include prediction status data and prediction alarm data. The system may further include an event processor configured to process an alarm of the live alarm data or the prediction alarm data. The event processor may be further configured to send an alert to one or more receiver applications of a plurality of receiver applications. Each PMD may include a standalone vehicle (e.g. an OEM vehicle) and an IoT device attached to the standalone vehicle, wherein the standalone vehicle includes a power controller. The IoT device and the power controller may be communication coupled to each other. The live data may include the first data and the second data.

An aspect of the disclosure relates to a method for handling events of a fleet of personal mobility devices, wherein each PMD may include a standalone vehicle and an IoT device attached to the standalone vehicle, wherein the standalone vehicle includes a power controller configured to generate first data, and the IoT device is configured to generate second data. The method may include receiving, at a server, live data from the fleet of PMDs. The method may further include storing the live data in the first memory as part of historical data. The method may further include providing, by a classifier included in a processing logic of the server, prediction data based on at least one of: the historical data, the live data. The live data may include live status data and live alarm data. The prediction data may include prediction status data and prediction alarm data. The method may further include processing, by an event processor, an alarm of the live alarm data or the prediction alarm data into an alert. The method may further include sending the alert to one or more receiver applications of a plurality of receiver applications.

According to various embodiments, the live data may include first data originating from the power controller and second data originating from the IoT device of a PMD of the fleet.

According to various embodiments, the server may be configured to request live data, from each of the PMDs, for example each of the PMDs that are operational, repeatedly at a pre-defined time interval.

According to various embodiments, each PMD of the fleet may be configured to send the live alarm data independently of a server request, for example immediately, to the server when an alarm event has occurred. In some embodiments, the system comprises the server and other elements configured to be used with the PMDs 200 while the system does not include the PMDs 200. In other embodiments, the system may be a system with fleet 20, thus including the PMDs 200.

According to various embodiments, the live alarm data and the prediction alarm data may be of an alarm data type, and wherein the alarm data type may be different from a data type of the live status data and a data type of the predicted status data.

According to various embodiments, the server requests live data, from each of the PMDs which may be operational, repeatedly at a pre-defined time interval.

According to various embodiments, the method for handling events may further include the server requesting live data, from each of the PMDs which may be operational, repeatedly at a pre-defined time interval. Accordingly, the server may be configured to request live data, from each of the PMDs that are operational, repeatedly at a pre-defined time interval.

According to various embodiments, each PMD of the fleet may send the live alarm data independently of a server request, for example immediately, to the server when an alarm event has occurred. The alarm event may be for an alarm having a pre-defined criticality. Accordingly, each PMD, e.g. each IoT device, of the fleet may be configured to send the live alarm data independently of a server request, for example immediately, to the server when an alarm event has occurred.

According to various embodiments, the first data may be generated by the power controller based on signal from OEM sensors, which optionally may include one or more of: battery sensor, accelerometer, brakes sensor.

According to various embodiments, the second data may be generated by the IoT device based on at least one of signal from IoT sensors, first data received from the power controller, a combination thereof.

According to various embodiments, the IoT sensors may include at least one of: accelerometer, GPS sensor.

According to various embodiments, the second data may include joint data, which may include two or more of: accelerometer data, GPS data, brake data, speed data, which may be based on accelerometer data from the accelerometer, on GPS data from the GPS sensor, on brake data from the brakes sensor, and speed data from the speed sensor, respectively.

According to various embodiments, the second data may include one or more of: data of road bumps, travel length, travel route, speed, acceleration, brake distance, brake speed, battery voltage sensor, alarms which may be triggered and self-resolved. Any one or more of speed, acceleration, brake distance and brake speed, generated by the IoT device may be based from data of a 3 axis gyroscope sensor and/or the GPS sensor.

According to various embodiments the event processor may include a trouble-shooter logic and an event router. The trouble-shooter logic may be configured to carry out troubleshooting an issue related to an alarm. The troubleshooting may include trying to re-establish communication with a PMD with which communication may be lost and/or communicating with the problematic PMD to resolve or mitigate the issue. The trouble-shooter logic may be further configured to generate a result of the troubleshooting.

According to various embodiments, live data may be generated based on a battery voltage. The prediction status data may include a battery fault prediction. Alternatively or in addition, the prediction alarm data comprises a battery fault prediction alarm.

According to various embodiments, The IoT sensors may include a battery voltage sensor. The second data may be generated by the IoT device based on at least signal from the battery voltage sensor.

According to various embodiments, the method for handling events may further include sending, by the event router included by the event processor, an alert to the one or more receiver applications of the plurality of receiver applications based on a criticality level of the alarm and/or on the result of the troubleshooting. Accordingly, the event router may be configured to, based on a criticality level of the alarm and/or on the result of the troubleshooting, send an alert to the one or more receiver applications of the plurality of receiver applications.

According to various embodiments, the plurality of receiver applications may include: operations team application, user application, maintenance team application.

According to various embodiments, the method for handling events may further include, receiving the historical data and/or the live data by a categorizer included in the processing logic, and attributing, by the categorizer, a category to the respective data. The method may further include inputting the categories into the classifier. Accordingly, the processing logic may include a categorizer configured to, receive the historical data and/or the live data, and attribute a category to the respective data. The categories may be input into the classifier. The categories may be, for example, one or more of: battery, brakes, speed, road conditions.

According to various embodiments, historical data may further include user historical data.

According to various embodiments, prediction data may include a number of brakings for a trip.

According to various embodiments, prediction data may include at least one of: a risk level for a user, a risk level for a trip, a risk level for a PMD.

According to various embodiments, each of the power controller and the IoT device may include a respective security engine configured to provide encrypted communication with each other.

According to various embodiments, the server may include a server side encryption engine and each IoT device of each of the PMDs may include an IoT side encryption engine, the server side encryption engine being and the IoT side encryption engines configured to provide encrypted communication with each IoT device.

According to various embodiments, the live data may include live battery data. The prediction status data may include a battery fault prediction. Alternatively or in addition, the prediction alarm data comprises a battery fault prediction alarm.

According to various embodiments, the live battery data may be based on a battery voltage, for example, obtained by a battery voltage sensor comprised by the IoT sensors.

According to various embodiments a PMD may be an electric scooter.

### BRIEF DESCRIPTION OF THE DRAWINGS

The invention will be better understood with reference to the detailed description when considered in conjunction with the non-limiting examples and the accompanying drawings, in which:

FIG. 1 shows a schematic view of a system 10 in communication with a fleet 20 in accordance with various embodiments;

FIG. 2 shows details of a PMD 200 in accordance with various embodiments;

FIG. 3 shows a flowchart of a method 700 including generation of first data 251 and second data 252, in accordance with various embodiments;

FIG. 4 shows a flow chart of a method 800 for receiving and processing live 250 data by the server 100, in accordance with various embodiments;

FIG. 5 shows details of the event processor 120, in accordance with various embodiments;

FIG. 6 shows an example of an alert criticality and which receiver applications receive the alert, in accordance with various embodiments;

FIG. 7 shows details of a security layer implemented for communications according to various embodiments;

FIG. 8 shows an exemplary flowchart for directing events provided by PMDs to receiver applications and activating a remote session, in accordance with various embodiments;

FIG. 9 shows an exemplary flowchart for connecting the server 100 with a PMD 200; and

FIG. 10 shows details of a method 900 for receiving and processing live 250 data by the server 100, in accordance with various embodiments, wherein second data includes battery sensor signal;

FIG. 11 shows an exemplary computer architecture 90 with which the server 100 may be implemented in accordance with various embodiments.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the systems or methods are analogously valid for the other systems or methods. Similarly, embodiments described in the context of a systems are analogously valid for a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In some embodiments, the system comprises the server and other elements configured to be used with the PMDs while the system does not include the PMDs. In other embodiments, the system is a system with the fleet, thus including the PMDs.

As used herein, and in accordance with various embodiments, the expression “live data” may mean data received from one PMD or from more than one PMD. Live data may include live status data and live alarm data. Live data may include a timestamp which is provided by the PMD and is, for example, less than 2 h old, for example, less than 15 minutes old, or equal or less than 2 minutes old. In contrast to live data, “historical data” is data which is read from the first memory, historical data may be created and/or stored based on one or more of: predicted data, user data, live data. Historical data may include data with a timestamp older than live data, for example, older than the latest read live data, such as older than 2 h. The historical data may include, data of road bumps.

As used herein, and in accordance with various embodiments, the expression “live status data” may include one or more of gps, speed, acceleration, brake distance, battery information.

As used herein, and in accordance with various embodiments, the expression “live alarm data” may include one or more of error codes for vehicle, error codes for iot devices. According to various embodiments, when status data meets pre-determined conditions, alarms may be triggered generating live alarm data, for example, when speed exceeds a pre-determined threshold, e.g., speed greater than 25 km/gh, an alarm may be triggered.

As used herein, and in accordance with various embodiments, the expression “prediction data” may mean data provided by the first processing logic, for example, by the classifier. The prediction data may include prediction status data and prediction alarm data. The prediction status data may represent a probability of status change for each of a plurality of status and/or may represent an additional status which is not provided by the live data. The prediction alarm data may represent a probability of an alarm change and/or may represent an additional alarm which is not provided by the live data. For example, the live status data may provide a status representing the battery charge, and the prediction status data may provide an additional status representing a battery wear and/or a fault risk. The prediction data may be based on at least one of: the historical data, the live data. The live data may include live status data and live alarm data. The prediction data may be further based on an order status and/or a user usage status which may be obtained from the server side.

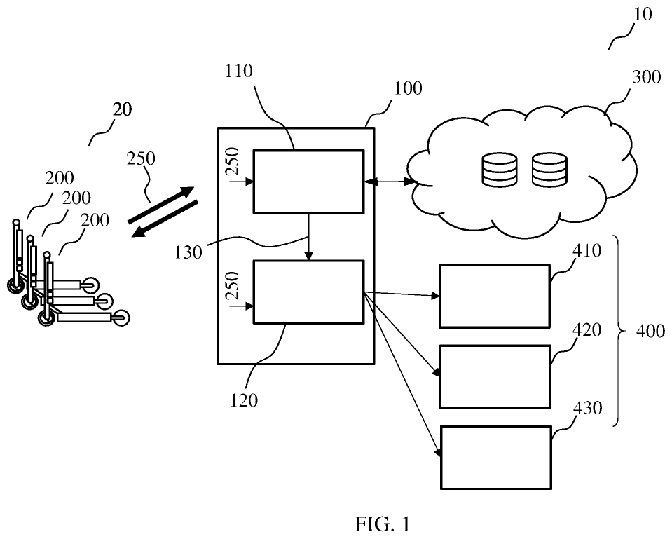

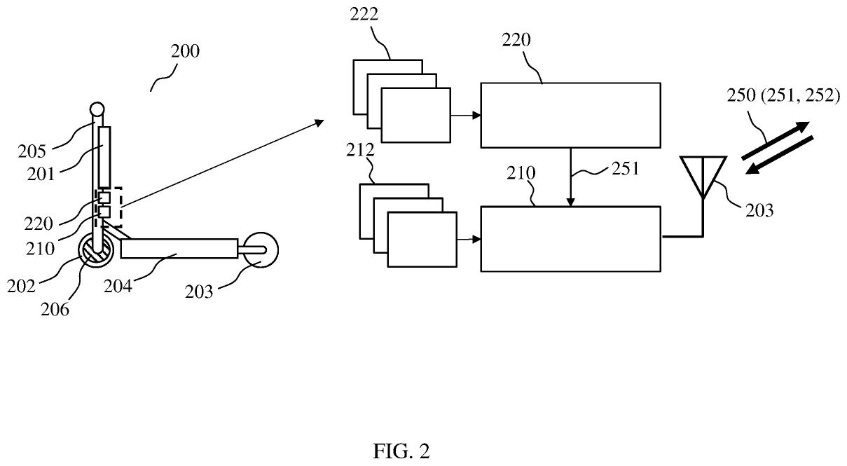

FIG. 1 shows a schematic view of a system 10 in communication with a fleet 20 in accordance with various embodiments. The fleet 20 comprises personal mobility devices 200 (PMDs). According to various embodiments, the number of PMDs 200 in the fleet 20 may be larger than 3, for example 100 or more, such as 1000 or more, for example 1000 to 65000. Exemplary details of a PMD 200 are given in connection with FIG. 2. According to various embodiments, a PMD 200 may be an electric scooter.

According to various embodiments, each PMD 200 may include a standalone vehicle and an IoT device 210 attached to the standalone vehicle. The standalone vehicle is a vehicle which is able to be operated without requiring connection to a server 100, for example an OEM vehicle, such as an OEM electric scooter. The standalone vehicle may include a power controller 220, which may control one or more of: battery use, accelerator signal, driving motor power, brakes, lights. The power controller 220 may include a logic circuit, e.g., a microprocessor, configured to receive signals from OEM sensors 222, and may further be configured to process signals from the OEM sensors 222 into first data 251, and may further be configured to send the first data 251 to the IoT device 210. The addition of an IoT device to the standalone vehicle allows to collect an extensive set of sensor data and trip patterns without impacting user experience (e.g. fast locking/unlocking of the PMD), and allows for collection of most part of useful live data without requiring significant investment in additional embedded hardware.

According to various embodiments, the first data may be generated by the power controller 220 based on signal from OEM sensors 222, which optionally may include one or more of: battery sensor, accelerator sensor, brakes sensor.

According to various embodiments, the IoT device 210 provides communication with the power controller 220 and wireless communication with the server 100. The IoT device 210 may include a microprocessor configured to receive signals from IoT device sensors 212, to process the signals from the IoT device sensors 212 into second data 252, and to receive first data 251 from the power controller 220. According to various embodiments the IoT sensors may include at least one of: accelerometer, GPS sensor, battery voltage sensor. According to various embodiments, the second data may be generated by the IoT box based on at least one of: signal from IoT sensors 212, first data received from the power controller 220, a combination thereof. According to various embodiments, the second data may include joint data, which may include two or more of: accelerometer data, GPS data, brake data, speed data, which may be based on accelerometer data from the accelerometer, on GPS data from the GPS sensor, on brake data from the brakes sensor, and speed data from the speed sensor, respectively.

According to various embodiments, second data may include one or more of: data of road bumps, travel length, travel route, speed, acceleration, brake distance and brake speed, battery voltage sensor, alarms which may be triggered and self-resolved. Any one or more of speed, acceleration, brake distance, brake speed, generated by the IoT device may be based from data of a 3 axis gyroscope sensor and/or the GPS sensor.

According to various embodiments, the IoT device may be powered by a battery of the vehicle. The IoT device 210 further includes a wireless communication device 804 configured to communicate with the server 100, for example via the mobile phone network. The wireless communication device may include an antenna. The IoT device 210 is configured to send live data 250 (which includes the first data 251 and the second data) to the server 100. Such a configuration, wherein the IoT device is attached to the stand alone vehicle has advantages, as no costly and complex modifications are required to the stand alone vehicle to provide for the additional features. In particular, the power controller may be used without changes in hardware and/or firmware, and a communication coupling with the IoT device may be sufficient.

According to various embodiments, the IoT device may be configured to maintain persistent connection round-the-clock with possible retries to connect with the server 100. This way, the IoT devices 210 are free to upload any information to the server 100 side at any time, for example the first data or second data 252, and/or critical alarms. The server 100 may store and maintain the status of all the devices in databases, which may be checked by the operations staff as per their permissions. Besides, when necessary, the server 100 may push certain commands to the IoT devices to proactively control their behaviors, such as locking/unlocking, forcing over-the-air (OTA) update, setting top speed, and stopping any abnormal behaviors. In addition, unified subscriber identity module (SIM) cards may be installed into all the IoT devices. Lastly, the fully bidirectional communication channel between server 100 and the IoT devices, along with the extremely lean data packets transferred, enables super-fast communication between the server 100 and the IoT devices 210 and smooth user experiences of using the PMDs 200.

According to various embodiments, the IoT device 210 and the power controller 220 may be communication coupled to each other, for example via conductor cables(s). The communication coupling may be provided as a CAN bus. The communication coupling may further include wiring for supplying power from the PMD 200 to the IoT device (210).

According to various embodiments, each of the PMDs 200 is configured to communicate with the server 100. According to various embodiments, the system 10 may include a server 100 configured to receive live data 250 from the fleet 20 of PMDs 200. The live data may include first data 251 originating from the power controller 220 and second data 252 originating from the IoT device of a PMD 200 of the fleet 20.

According to various embodiments, the server 100 may be configured to request live data, from each of the PMDs 200 that is operational, repeatedly at a pre-defined time interval. In accordance with various embodiments, the pre-defined time interval may be selected from 0.5 seconds to 100 seconds, for example 5 seconds. According to some embodiments, a first portion of live data may be uploaded more frequently than a second portion, for example the pre-defined internal for basic data including one or more of speed, location, acceleration, battery status, may be lower (e.g., 5 seconds) than for the second data (e.g., 100 seconds).

According to various embodiments, the PMD 200 may include the battery pack 201 according to various embodiments. The PMD 200 may be an electric scooter. According to various embodiments, the electric scooter may be configured as a vehicle that is to be used by a user, has two or more wheels 202, 203, and is propelled or can be selectively propelled by an electric motor 206 attached to the electric scooter. According to various embodiments, the electric scooter may be configured as a form of personal transportation for movement of user from one location to another location. The electric scooter may include a main body including a rider-support-platform structure 204 and a steering column 205 coupled to the rider-support-platform structure 204. According to various embodiments, the rider-support-platform structure 204 may be configured to support a rider directly standing on top of the rider-support-platform structure 204. For example, the rider-support-platform structure 204 may be a deck of an electric scooter configured for a rider to stand on. According to various embodiments, the rider-support-platform structure 204 may be aligned horizontally with respect to ground. According to various embodiments, the electric scooter may include a wheel arrangement supporting a main body. The wheel arrangement may include at least one front wheel 202 and at least one rear wheel 203. According to various embodiments, the wheel arrangement may be supporting the main body in a manner such that the main body is elevated above the ground. Accordingly, only the at least one front wheel 202 and the at least one rear wheel 203 may be in contact with the ground. Hence, the electric scooter may be moved with respect to the ground via the rotation or turning of the at least one front wheel 202 and the at least one rear wheel 203. According to various embodiments, the at least one front wheel 202 may be configured to be steerable by a steering column 205. According to various embodiments, the steering column 205 may be extending in an upward direction with respect to the rider-support-platform structure 204. According to various embodiments, the at least one front wheel 202 may be coupled to the steering column 205. According to various embodiments, the steering column 205 may include a front wheel fork which holds the at least one front wheel 202. While an electric scooter is described and used to describe various embodiments, the disclosure is not limited thereto.

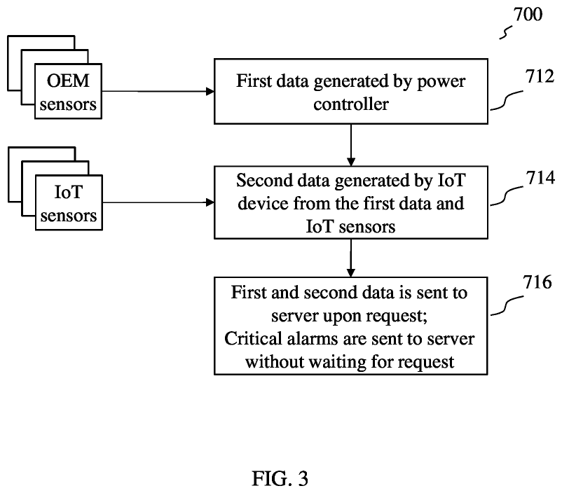

FIG. 3 shows a flowchart of a method 700 including generation of first data 251 and second data 252, in accordance with various embodiments. The power controller 220 receives signals from the OEM sensors and generates first data on 712. First data is transmitted to the IoT device 210. The IoT device 210 receives signal from the IoT sensors (for example an accelerometer integrated in the IoT device). The IoT device 210 may generate second data 252 from the IoT sensors and/or the first data 251. The IoT device 210 may send the first data and the second data to the server 100. For example, the server 100 may request, at regular time intervals, that the IoT device 210 sends the first data 251 and the second data 252 to the server 100. In addition, the IoT device 210 may send critical alerts to the server, independently from a request from the server 100. Thus, the server 100 may have access to first data 251 from the power controller 220 and to the second data 252 from the IoT device 210.

Turning again to FIG. 1, according to various embodiments, the system 10 may include a first memory 300, and the server 100 may be further configured to store the live data in the first memory 300. The live data stored in the first memory 300 may be accumulated as part of historical data. According to various embodiments historical data may further include user historical data, which is user data, for example a user risk, accumulated over time. User data may be generated by the server or provided by another server, for example, having a privacy layer for enhanced private data protection. The first memory 300 may be included in the server 100 or may be external to the server 100, for example distributed in a computing cloud. The server 100 may also be implemented in a computing cloud, for example in a computing cloud including the first memory 300.

According to various embodiments, the system 10 may include a processing logic 110 including a classifier configured to provide prediction data based on at least one of: the historical data, the live data. The prediction data may further be based on order status and/or user usage status which may be obtained from the server side. The processing logic 110 may be included in the server 100. The live data 250 may include live status data and live alarm data. The prediction data 130 may include prediction status data and prediction alarm data. The classifier may be a trained classifier. According to various embodiments, prediction data may include a number of braking for a trip. Alternatively or in addition, prediction data may include at least one of: a risk level for a user, a risk level for a trip, a risk level for a PMD 200. Accordingly, the method may include receiving the historical data and/or the live data by a categorizer included in the processing logic 110, and attributing, by the categorizer, a category to the respective data, and may further be including inputting the categories into the classifier. According to various embodiments, the processing logic 110 may include a categorizer configured to, receive the historical data and/or the live data, and attribute a category to the respective data: battery, brakes, speed, road conditions, which categories may be input into the classifier. The categories may be used as additional input for the function of the classifier.

According to various embodiments, the system 10 may include an event processor 120 configured to process an alarm of the live alarm data or the prediction alarm data. The event processor 120 may be included in the server 100. The event processor 120 may be configured to receive alarms from the live alarm data and alarms from the prediction alarm data. For example, the event processor may receive an alarm of the live alarm data and process this alarm, next, the event processor may receive an alarm of the prediction alarm data and process this alarm. The event processor 120 may be configured to send an alert to one or more receiver applications of a plurality of receiver applications 400, for example depending on a criticality of the alert.

According to various embodiments, the live alarm data and the prediction alarm data may be of an alarm data type, and wherein the alarm data type may be different from a data type of the live status data and a data type of the predicted status data. The different data type allows the server 100, for example the event processor 120, to quickly identify alarms within the live data and prediction data, so that downstream processes can be carried out with the required urgency.

According to various embodiments, the event router 114 may be configured to, based on a criticality level of the alarm and/or on the result of the troubleshooting, send an alert to the one or more receiver applications of the plurality of receiver applications 400.

According to various embodiments the plurality of receiver applications 400 may include one or more of: operations team application 410, user application 420, maintenance team application 430. For example, a user application 420 may be an app on a user's hand held device, e.g., on a mobile phone.

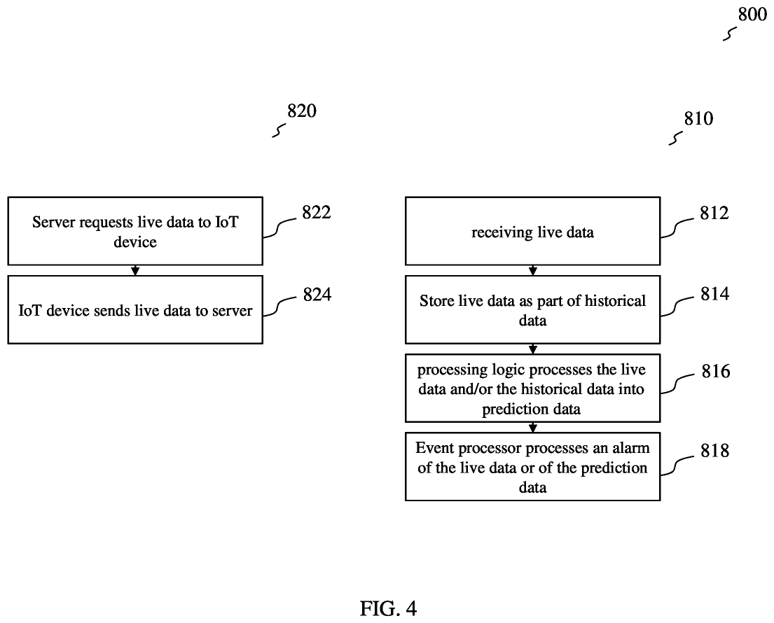

An aspect of the disclosure relates to a method for handling events of a fleet of personal mobility devices. FIG. 4 shows an exemplarily flow chart of a method 800, wherein method 810 is carried out by the server 100 and method 820 may be carried out by on PMD 200 side. FIG. 4 shows an exemplarily flow chart of a method 800 for handling, e.g., receiving and processing, live 250 data by the server 100, in accordance with various embodiments, however the disclosure is not limited thereto, and the method may include more or less steps as shown. In the fleet 20, each PMD 200 may include a standalone vehicle and an IoT device 210 attached to the standalone vehicle, the standalone vehicle including a power controller 220 configured to generate first data 251, and the IoT device 210 being configured to generate second data 252. Details of systems and PMDs and exemplary systems and PMDs are explained in other embodiments herein. The method 810 may include receiving at the server 100, e.g. by the server 100, live data 250 from the fleet 20 of PMDs 200, for example at a receiving step 812. The method 810 may further include storing the live data 250 in the first memory 300 as part of historical data, for example in a storing step 814. The method 810 may further include providing, by the classifier included in the processing logic 110 of the server 100, prediction data based on at least one of: the historical data, the live data, for example in a prediction data processing step 816. The prediction data may further be based on order status and/or user usage status which may be obtained from the server side. The live data may include live status data and live alarm data. The prediction data 130 may include the prediction status data and the prediction alarm data. The method 810 may further include processing, by the event processor 120, an alarm of the live alarm data or the prediction alarm data into an alert, for example, in an event processing step 818. The method 810 may further include sending the alert to one or more receiver applications of a plurality of receiver applications 400. The live data may include the first data 251 and the second data 252. According to various embodiments the server 100 requests live data, from each of the PMDs 200 which may be operational, repeatedly at a pre-defined time interval.

Method 820 may be carried out by one of the PMDs 200, which receives request to provide live data to the server 100, for example on a request receiving step 822. Upon receiving the request form the server 100, the IoT device 210 may send the live data 250 to the server 100, for example in a sending step 824.

According to various embodiments each PMD 200 of the fleet 20 may be configured to send the live alarm data independently of a server 100 request, for example, immediately, to the server 100 when an alarm event has occurred.

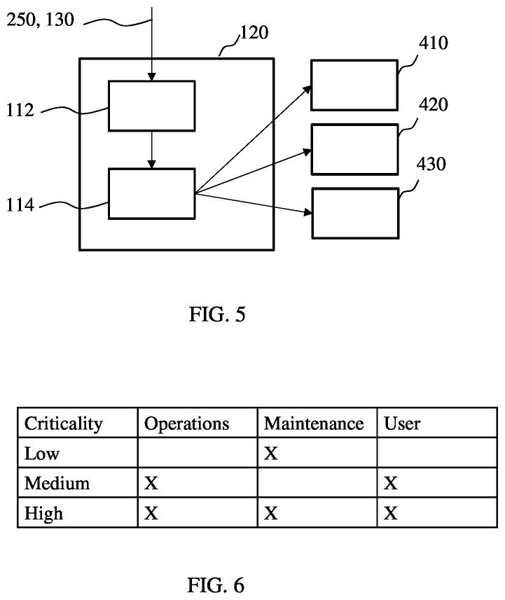

FIG. 5 shows details of the event processor 120, in accordance with various embodiments. According to various embodiments, the event processor 120 may include a trouble-shooter logic 112 and an event router 114. The trouble-shooter logic 112 may be configured to receive an alarm of the prediction data 130 or of the live data 250, and may further be configured to receive the prediction data 130 and/or the live data 250. The trouble-shooter logic 112 may be configured to carry out troubleshooting an issue related to the alarm, for example, by trying to re-establish communication with a PMD 200 with which communication may be lost, and/or by communicating with a problematic PMD 200 to resolve or mitigate the issue, and may be further configured to generate a result of the troubleshooting.

According to some embodiments, the event router 114 may be configured to receive the alarm and/or the result of the troubleshooting. The event router 114 may be further configured to receive the prediction data 130 or of the live data 250, and may further be configured to receive the prediction data 130 and/or the live data 250. In some embodiments without a trouble shooter, the event router 114 may be configured to receive the to receive an alarm of the prediction data 130 or of the live data 250, and may further be configured to receive the prediction data 130 and/or the live data 250, for example from the processing logic 110.

According to various embodiments, the method for handling events (e.g. the method 810) may include sending, by the event router 114 included in the event processor 120, an alert to the one or more receiver applications of the plurality of receiver applications 400 based on a criticality level of the alarm and/or on the result of the troubleshooting. According to various embodiments, the event router 114 may be configured, based on a criticality level of the alarm and/or on the result of the troubleshooting, send an alert to the one or more receiver applications of the plurality of receiver applications 400. The alert may contain data about the alarm and/or the result of the trouble shooting.

According to various embodiments the plurality of receiver applications 400 may include one or more of operations team application 410, user application 420, maintenance team application 430. It is understood that the user application 420 is the one of the user using the respective PMD 200 which corresponds to the alert.

FIG. 6 shows an example of an alert criticality and which receiver applications receive the alert, in accordance with various embodiments. For example, an alert with a low criticality may be sent to the maintenance team application 430. Therefore, when scheduled maintenance takes place, the maintenance team may take care of the issue related to the alert. An alert with a medium criticality may be sent to the operations team application 410 and, if the PMD 200 is in operation, to the user application 420 for notifying the user. An alert with a high criticality may immediately take the PMD offline, may be sent to the operations team application 410, and may further be sent to the user application 420, and to the maintenance team application 430. Therefore, a user may be immediately informed of an issue and may therefore terminate his trip. The operations team receiving the alert on the operations team application 410, may, if necessary, provide further assistance to the user. The operations team may flag the PMD 200 or maintenance.

FIG. 6 shows only an example on how the alert may be send to the one or more receiver applications of the plurality of receiver applications 400. The deciding logic may include other parameters, for example, a status of the PMD 200 being in operation, a location of the PMD 200, a speed of the PMD 200.

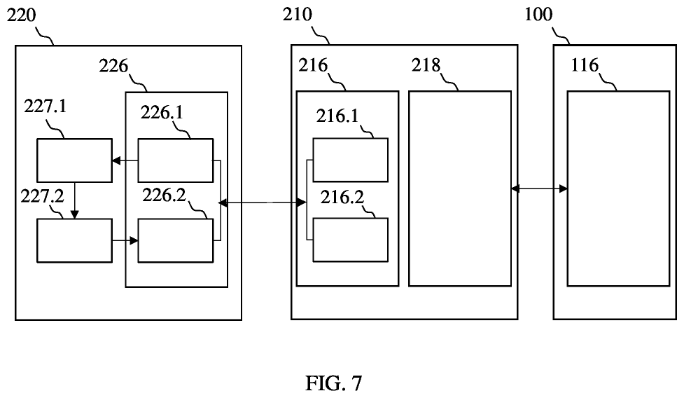

FIG. 7 shows details of a security layer implemented for communications according to various embodiments. FIG. 7 shows the power controller 220 communication coupled to the IoT device 210 which is configured to communicate with server 100. According to various embodiments each of the power controller 220 and the IoT device may include a respective security engine 216, 226 configured to provide encrypted communication with each other. According to various embodiments the server 100 may include a server side encryption engine 116 and each IoT device of each of the PMDs 200 may include an IoT side encryption engine 218, the server side encryption engine 116 and the IoT side encryption engine 218 being configured to provide encrypted communication.

In some embodiments, the security engine 226 of the power controller 220 may include an Advanced Encryption Standard (AES) decoder 226.1 and an AES encoder 226.2. The power controller 220 may include an AT command receiver 227.1 to receive AT commands decrypted by the AES decoder 226.1. The power controller 220 may further include an AT command responder 227.2 to send AT command responses to the AES encoder 226.2 which encrypts the commands before sending these to the IoT device 210.

In some embodiments, the security engine 216 of the IoT device 210 may include an AES encoder 216.2 and an AES decoder 216.1 for encrypted communication with the power controller 220. The AES encoder 216.2 may receive AT commands generated in the IoT device 210 to be encrypted and send to the power controller 220. The AES decoder 216.1 may receive AT command responses from the power controller 220, decrypt these, and provide the decrypted AT command responses to other circuits in the IoT device.

In some embodiments, the IoT side encryption engine 218 may be a Transport Layer Security (TLS) engine and the server side encryption engine 116 may be another TLS engine to provide the encrypted communication. The IoT device 210 and the server 100 may be configured to communicate using the Message Queuing Telemetry Transport (MQTT) protocol via the TLS engines 218, 116.

According to various embodiments PMD 200 may be an electric scooter.

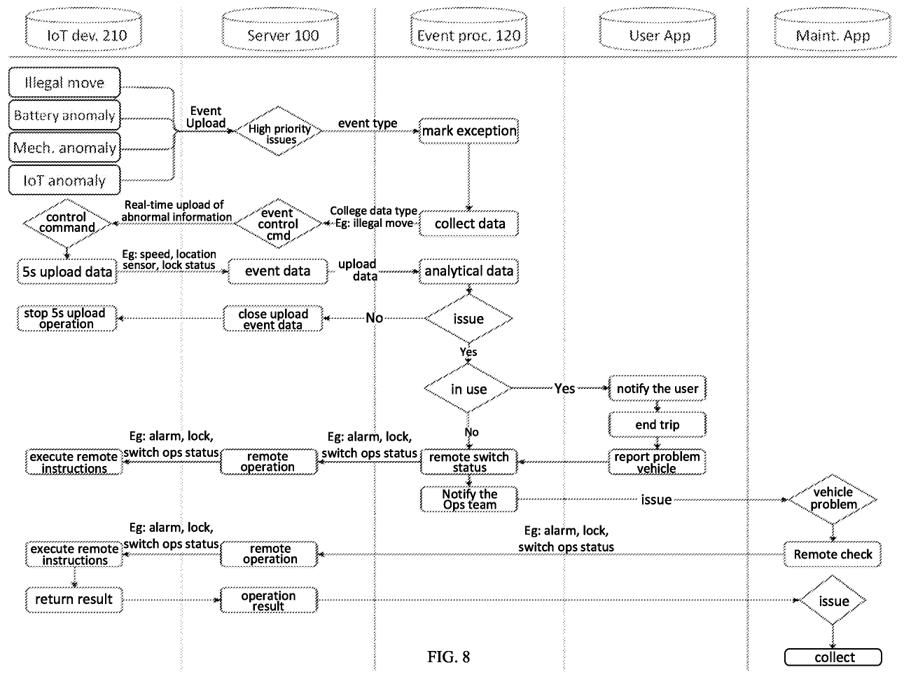

FIG. 8 shows an exemplary flowchart for directing events provided by PMDs to receiver applications and activating a remote session, in accordance with various embodiments. As example of alarms (or events), FIG. 8 shows illegal move, battery anomaly, mechanical anomaly, IoT anomaly, however the disclosure is not limited thereto. The alarms are sent to the server, which may be an MQTT server. When the alarms are of a high criticality (e.g. due to events representing high priority issues) the event processor initiates data collection, for example requesting live data from the IoT device 210 repeatedly at a pre-defined time interval. In accordance with various embodiments, the pre-defined time interval may be selected from 0.5 seconds to 100 seconds, for example 5 seconds. The live data may then be analyzed by the server 100. The trouble-shooter logic 112 may then carry out troubleshooting of an issue related to the alarm, for example, by trying to re-establish communication with a PMD 200 with which communication may be lost, and/or by communicating with a problematic PMD 200 to resolve or mitigate the issue. If a result of the troubleshooting indicates that the issue related to the alarm is resolved normal communication may be reestablished.

If the issue remains unresolved, the user may be notified of the issue, for example, it may be checked if the PMD 200 is in use, and if this check is affirmative, an alert may be sent to the user application 420 to inform the user of the issue, so that the trip can be ended.

In the case when the PMD is not in use, or the trip has ended, the status of the PMD may be switched into remote status, for example by the event processor 120.

The operations team application 410 may also receive an alert to allow the operations team to initiate remote operation. For example, remote operation may be initiated in the case when the PMD is not in use, for example, when the above check is negative or a trip has ended.

Remote sessions may be triggered for high criticality alerts. The high criticality alerts are related to high priority issues. The operations team can take remotely control of the PMD, switch the IoT status on the PMD (e.g., from operational into remote operation), and perform basic troubleshooting of battery, ECU, and IoT connectivity, as well as trigger live pull of vehicle data via IoT connections. Operations team can also remotely power off the PMD and lock it down, as well as sending the closest staff member to collect the PMD in question.

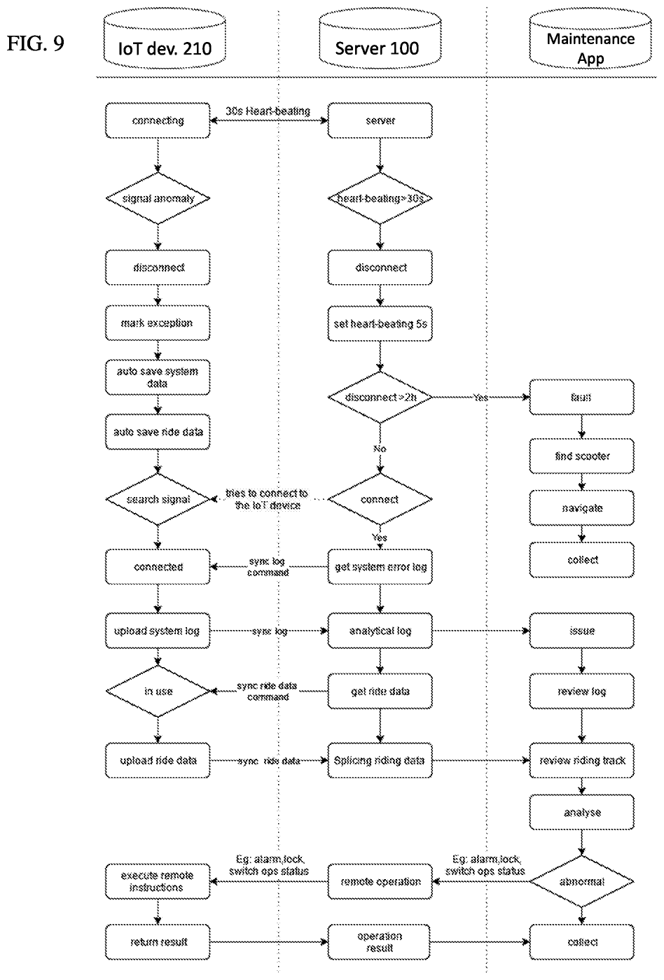

FIG. 9 shows an exemplary flowchart for connecting the server 100 with a PMD 200. The Iot device 210 may transmit live data to the server at a heart beat (also named herein as periodic request) of a pre-determined time interval, for example a low frequency having a time interval of 30 seconds. The live data may be sent by the IoT device 210 upon request from the server. On the IoT device 210 side, if a signal anomaly is detected, the IoT device 210 will interrupt the communication and/or disconnect the connection with the server, mark an exception and save the exception into the second data 252. The IoT device 210 may try to reestablish connection with the server 100. Meanwhile on the server 100 side, the server will change into high frequency communication, setting the pre-determined time interval at a time interval lower than for the low frequency, for example 5 seconds. The server 100 will try to reconnect with the IoT device 210 until a connection is achieved or until a timeout time has passed during which no connection is achieved, for example a time out time of 2 h has passed. If no connection is achieved, the server sends and alert to the field application, so that the field team may proceed into locating the defective PMD. The filed application may have functions to find the scooter, provide navigation for the field team, and instructions to collect the defective PMD.

In the case when connection is reestablished, the server 100 will request live data from the IoT device 210, and may synchronize the error log on server side. The live data may include the ride data, and the error data stored due to the loss of communication.

The server analyses the live data and decides whether the data is normal and can be processed or whether the data is abnormal in which case the server 100 may continue to request live data from the IoT device 210 until the data becomes normal. For example, data may be (re) requested every 5 minutes. An abnormal data alarm may be triggered when the data remains abnormal for over a pre-determined time

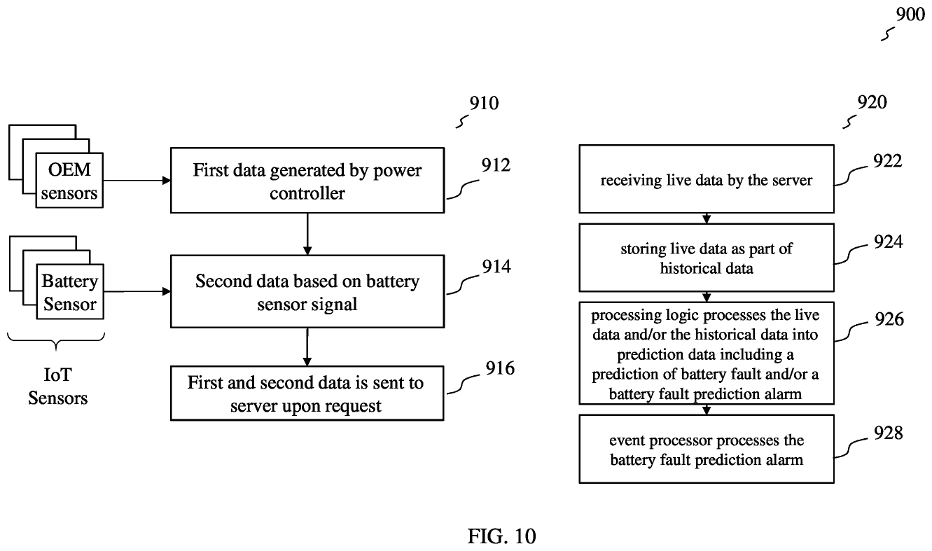

FIG. 10 shows details of a method 900 for receiving and processing live 250 data by the server 100, in accordance with various embodiments, wherein second data includes battery sensor signal. A flowchart 910 of method 900 includes generation of first data 251 and second data 252, in accordance with various embodiments. The power controller 220 receives signals from the OEM sensors and generates first data on 912. First data is transmitted to the IoT device 210. The IoT device 210 receives signal from the IoT sensors (for example an accelerometer integrated in the IoT device). The IoT device 210 may generate second data 252 from the IoT sensors and/or the first data 251 on 914. The IoT device 210 includes a battery sensor, for example a battery voltage sensor. The second data is generated by the IoT device based on at least a signal from the battery voltage sensor, for example the second data may include a battery voltage. The IoT device 210 may send the first data and the second data to the server 100 on 916. For example, the server 100 may request, at regular time intervals, that the IoT device 210 sends the first data 251 and the second data 252 to the server 100. In addition, the IoT device 210 may send critical alerts to the server, independently from a request from the server 100. Thus, the server 100 may have access to first data 251 from the power controller 220 and to the second data 252 from the IoT device 210.

A flowchart 920 of method 900 includes receiving at the server 100, e.g. by the server 100, live data 250 from the fleet 20 of PMDs 200, for example at a receiving step 922. When live data 250 includes second data based on a battery voltage, the live data 250 is generated based on a battery voltage.

The method 920 may further include storing the live data 250 in the first memory 300 as part of historical data, for example in a storing step 924. Thereby the historical data may include historical battery data, for example a history of the battery voltage. The method 920 may further include providing, by the classifier included in the processing logic 110 of the server 100, prediction data based on at least one of: the historical data, the live data, for example in a prediction data processing step 926. The prediction data may further be based on order status and/or user usage status which may be obtained from the server side. The live data may include live status data and live alarm data. The prediction data 130 may include the prediction status data and the prediction alarm data. The prediction status data may include a battery fault prediction, such that operations can check the battery of a PMD when doing maintenance. Alternatively or in addition, the prediction alarm data may include a battery fault prediction alarm such that action can be taken, for example powering off the PMD.

The method 920 may further include processing, by the event processor 120, an alarm of the live alarm data or the prediction alarm data into an alert, for example, in an event processing step 928. The method 910 may further include sending the alert to one or more receiver applications of a plurality of receiver applications 400. The live data may include the first data 251 and the second data 252. According to various embodiments the server 100 requests live data, from each of the PMDs 200 which may be operational, repeatedly at a pre-defined time interval.

Method 910 may be carried out by one of the PMDs 200, which receives request to provide live data to the server 100, for example on a request receiving step 822. Upon receiving the request form the server 100, the IoT device 210 may send the live data 250 to the server 100, for example in a sending step 916.

According to various embodiments, the classifier may be trained with a fault battery library, for example, extracted from the historical database. The fault battery library may include data obtained from battery inspections, for example once inspection confirms that the battery is faulty, the respective information may be added to the fault battery library. The fault battery library may include two or more of battery holding charge, battery running time, battery running time lower than a running time threshold, battery voltage under a pre-determined voltage threshold for more than a pre-determined time duration, accident record, temperature over a pre-determined temperature threshold, battery serial number, a determination of fault. A determination of fault may be included by an operator. The determination of fault may be used as ground trough for training of the classifier.

In one example, the classifier may be configured to classify a battery status into one or more of the classes: faulty, not-faulty, high risk of becoming faulty, fault alarm. These classes may be included into the prediction status data.

For example, when a battery voltage is lower than a pre-determined voltage threshold over a pre-determined time, and/or the battery is running at a rate that exceeds a pre-determined charging holding threshold, the classifier may detect a high risk of becoming faulty, and the PMD may be flagged for inspection. The system may repeatedly, e.g., twice per day, check all the batteries for predicting fault potential according to the algorithm learned from this fault battery library. If operations finds that there is indeed a problem, then the thresholds and classifier learning seem appropriate. If the battery is not in trouble, then thresholds may be readjusted and/or the classifier may be re-trained.

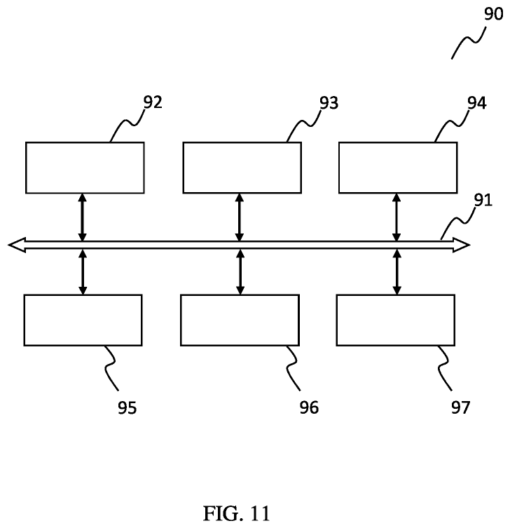

FIG. 11 shows an exemplary computer architecture 90 with which the server 100 may be implemented in accordance with various embodiments. The computer architecture 90 may include a bus 91 through which one or more of the devices may communicate with each other. In the example of FIG. 11, the following devices are shown connected to the bus 91: a CPU 92; a main memory 93, for example a RAM; a storage device 94, for example one or more of: a hard disk drive, a solid state drive, a flash drive; a communication device 95, for example for wired or wireless communication, e.g. WiFi, USB, Bluetooth, mobile network communication; a display interface 96, and other user interfaces 97, for example for user input; however the disclosure is not limited thereto, and more or less devices may be included in the computer and the computer and/or bus may have other architectures than the one illustrated.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A system for handling events of a fleet of personal mobility devices (PMDs), the system comprising:
the fleet comprising the personal mobility devices;
a server configured to receive live data from the fleet of PMDs; and
a first memory, wherein the server is further configured to store the live data in the first memory, which is accumulated as part of historical data,
wherein the server comprises a processing logic comprising a classifier configured to provide prediction data based on at least one of: the historical data, the live data,
wherein the live data comprises live status data and live alarm data, and
wherein the prediction data comprises prediction status data and prediction alarm data; and
an event processor configured to process an alarm of the live alarm data or the prediction alarm data, and send an alert to one or more receiver applications of a plurality of receiver applications,
wherein each PMD comprises a standalone vehicle and an IoT device attached to the standalone vehicle, the standalone vehicle comprising a power controller,
wherein the IoT device and the power controller are communication coupled to each other,
wherein the live data comprises first data originating from the power controller and second data originating from the IoT device of a PMD of the fleet, and
wherein the event processor further comprises a trouble-shooter logic configured to carry out troubleshooting an issue related to the alarm.

2. The system of claim 1, wherein the server is configured to request live data, from each of the PMDs which are operational, repeatedly at a pre-defined time interval.

3. The system of claim 1, wherein each PMD of the fleet is configured to send the live alarm data independently of a server request to the server when an alarm event has occurred.

4. The system of claim 1, wherein the live alarm data and the prediction alarm data are of an alarm data type, and wherein the alarm data type is different from a data type of the live status data and a data type of the predicted status data.

5. The system of claim 1, wherein the first data is generated by the power controller based on signal from OEM sensors, which optionally include one or more of: battery sensor, accelerator sensor, brakes sensor.

6. The system of claim 1, wherein the second data is generated by the IoT device based on at least one of:
signal from IoT sensors;
first data received from the power controller; and
a combination thereof.

7. The system of claim 6, wherein the IoT sensors include at least one of: accelerometer, GPS sensor, battery voltage sensor.

8. The system of claim 7, wherein second data comprises a joint accelerometer-GPS data which is based on accelerometer data from the accelerometer and on GPS data from the GPS sensor.

9. The system of claim 6, wherein second data comprises one or more of:
data of road bumps, travel length, travel route, speed, acceleration, brake distance, brake speed, battery voltage, alarms which are triggered and self-resolved.

10. The system of claim 1, wherein the event processor comprises an event router, wherein troubleshooting the issue related to the alarm is carried out, by trying to re-establish communication with a PMD with which communication is lost, and by communicating with a problematic PMD to resolve or mitigate the issue, and is further configured to generate a result of the troubleshooting.

11. The system of claim 10, wherein the event router is configured to, based on a criticality level of the alarm and/or on the result of the troubleshooting, send an alert to the one or more receiver applications of the plurality of receiver applications.

12. The system of claim 1, wherein the plurality of receiver applications comprises: operations team application, user application, maintenance team application.

13. The system of claim 1, wherein the processing logic includes a categorizer configured to, receive the historical data and/or the live data, and attribute a category to the respective data: battery, brakes, speed, road conditions, which categories are input into the classifier.

14. (canceled)

15. The system of claim 1, wherein prediction data comprises a number of braking for a trip.

16. The system of claim 1, wherein prediction data comprises at least one of: a risk level for a user, a risk level for a trip, a risk level for a PMD.

17. The system of claim 1, wherein each of the power controller and the IoT device comprises a respective security engine configured to provide encrypted communication with each other.

18. The system of claim 1, wherein the server comprises a server side encryption engine and each IoT device of each of the PMDs comprises an IoT side encryption engine, the server side encryption engine being and the IoT side encryption engines configured to provide encrypted communication with each IoT device.

19. The system of claim 1, wherein live data is generated based on a battery voltage, wherein the prediction status data comprises a battery fault prediction and/or wherein the prediction alarm data comprises a battery fault prediction alarm.

20. The system of claim 19, wherein the IoT sensors comprise a battery voltage sensor, and the second data is generated by the IoT device based on at least signal from the battery voltage sensor.

21. (canceled)

22. A method for handling events of a fleet of personal mobility devices (PMDs), wherein each PMD comprises a standalone vehicle and an IoT device attached to the standalone vehicle, the standalone vehicle comprising a power controller configured to generate first data, and the IoT device being configured to generate second data, the method comprising:
receiving at a server live data from the fleet of PMDs;
storing the live data in the first memory as part of historical data; and
providing, by a classifier comprised in a processing logic of the server, prediction data based on at least one of: the historical data, the live data,
wherein the live data comprises live status data and live alarm data, and
wherein the prediction data comprises prediction status data and prediction alarm data;
processing, by an event processor, an alarm of the live alarm data or the prediction alarm data into an alert and sending the alert to one or more receiver applications of a plurality of receiver applications,
wherein the live data comprises the first data and the second data; and
carrying out, by a trouble-shooter logic comprised by the event processor, troubleshooting an issue related to the alarm.

23-30. (canceled)
